(19) United States
(12) Patent Application Publication
(10) Pub. No.: US 2005/0215145 A1
(43) Pub. Date: Sep. 29, 2005

(54) Liquid resistant articles and method of producing the same

(76) Inventors: Cesar Hernan Guerrero, Miami, FL (US); Gary Wayne Moore JR., Miramar, FL (US)

Correspondence Address: BROMBERG & SUNSTEIN LLP, 125 SUMMER STREET, BOSTON, MA, 02110-1618, US

(21) Appl. No.: 10/808,734

(22) Filed: Mar. 25, 2004

(51) Int. Cl. B32B 3/00; B32B 27/04; B32B 27/12

(52) U.S. Cl. 442/59; 442/76; 442/77; 442/79; 442/82; 442/86; 442/87; 442/96; 442/152; 442/153

(57) ABSTRACT

In one embodiment of the invention, a garment includes a fabric with a plurality of pores. The pores have a size capable of permitting a given liquid with a surface tension below the critical surface tension of the fabric when treated with a fluorochemical to pass through the fabric. The fabric has an occluding composition applied thereto which prevent passage of the given liquid through the pores while allowing vapor passage through the pores. Other embodiments of the invention include specific constituents of the occluding composition and other compositions that may be applied to a garment. Further embodiments of the invention include garments, fabrics, fabric based articles, and methods for making such articles that include a composition to alter the properties of the fabric.

### TECHNICAL FIELD

The present invention relates to fabrics, garments and methods of producing the same. More particularly, the present invention relates to altering qualities of fabrics and garments.

### BACKGROUND ART

Conventional textile processes commonly produce garments from fabrics having specialized functional qualities. Among others, those qualities may include fluid repellency, stain resistance and release properties, wrinkle resistance, and microbial resistance. To obtain those qualities, such fabrics generally are subjected to specialized chemical treatments.

Many of those chemical treatments, however, only produce the desired results when applied to fabrics having very small pores. For example, one water resistance treatment applies a fluorochemical to fabrics having very small pores. Undesirably, the fluorochemical cannot adequately prevent (liquid) water penetration through fabrics having larger average pore sizes. One such fabric is denim, which is used in a wide variety of applications. This shortcoming significantly limits use of effective fluorochemicals to a limited number of applications.

Garments produced from pretreated fabrics also typically cannot be texture treated (or otherwise chemically treated or embellished in garment form) because such treatments often remove most of the noted chemical agents. Specifically, current industry practice commonly subjects many types of garments, including those with relatively large pores, to texture treatments. Denim pants, for example, often are texture treated with dry abrasive and wet chemical processes to provide a desired look and feel. If pre-treated fabrics are used to produce denim pants, then their chemical pre-treatment undesirably would be substantially removed by such abrasive treatments. Consequently, such pants would not have their intended quality (e.g., water repellency or anti-wrinkle qualities).

### SUMMARY OF THE INVENTION

A garment, in accord with an embodiment of the invention, includes a fabric having pores; and a thermoplastic elastomer applied to at least a selected portion of the fabric that includes the pores. The thermoplastic elastomer is configured to allow vapor passage through the plurality of pores. The garment may also include one or more of a liquid resistant composition (e.g., a fluorochemical) applied to the selected portion of the fabric; the liquid-resistant composition substantially prevents liquid from passing through the plurality of pores. Other compositions that may be used with the garment include one or more of a crosslinking composition and a microencapsulated odor neutralizing composition. Fabrics used with such embodiments include denim, which may or may not be texture-treated.

A garment, corresponding to another embodiment of the invention includes a fabric having pores. The fabric has a given critical surface tension if a fluorochemical is applied thereto. The plurality of pores each has a size capable of permitting a given liquid, with a surface tension that is no less than the given critical surface tension, to pass therethrough if a fluorochemical is applied to the fabric. The garment also includes an occluding composition applied to at least a selected portion of the fabric having the pores. The occluding composition is capable of substantially preventing passage of the given liquid through the pores while substantially allowing vapor passage through the pores. Fabrics that may be used with such an embodiment of the invention include denim and fabrics that are texture treated.

Other compositions that may be used with the aforementioned garment include one or more of a liquid resistant composition (e.g., a fluorochemical); a pore resistance composition; a crosslinking composition; a microencapsulated odor neutralizing composition; and a softening agent (e.g., an amino-modified copolymer silicone). Pore resistant compositions may include one or more of a wax, a thermoplastic elastomer, and a urethane. Examples of crosslinking compositions include one or more of a wrinkle-resistant composition; an inorganic salt and 2-imidazolidinone; and a glyoxal-based agent. Microencapsulated odor neutralizing compositions may include one or more of a scent composition and an odor neutralizing composition is capable of decreasing the vapor pressure of an odor composition (e.g., liposoluble essences of phosphate salts of 2,2′-oxybisethanol-2,2′-(methylimino)bisethanol).

Fabric-based articles, in a related embodiment of the invention, include a fabric having properties similar to those used in the previously discussed garments.

Another embodiment of the invention is a fabric that includes a fabric surface having pores. The fabric has a given critical surface tension if a fluorochemical is applied thereto. The pores each have a size capable of permitting a given liquid having a surface tension that is no less than the given critical surface tension to pass therethrough if a fluorochemical is applied to the fabric. The fabric also includes an occluding composition applied to at least a selected portion of the fabric having the pores. The occluding composition is capable of substantially preventing passage of the given liquid through the pores while substantially allowing vapor passage through the pores. Fabrics that may be used with such an embodiment of the invention include denim and fabrics that are texture treated. The occluding composition may include one or more of a liquid resistant composition; a pore resistance composition; a crosslinking composition; a microencapsulated odor neutralizing composition; and a softening agent.

Methods for making garments, in accord with embodiments of the invention, include providing a garment; and applying a composition to at least a portion of the garment, the composition being capable of substantially resisting liquid passage through the portion of the garment, and substantially allowing vapor passage through the portion of the garment. Applying the composition may include evenly applying an excessive amount of the composition to the garment (e.g., by spraying the composition on the garment while tumbling the garment); and removing an extra amount of the composition from the garment. Removing the extra amount of composition may be achieved by hydroextracting a portion of the extra amount of the composition from the garment; and drying the garment to remove a remaining portion of the extra amount of the composition from the garment. The method may further include heating the garment to spread the composition on the garment. Fabrics and compositions that may be used with these methods include those utilized with garments previously described. The composition may be applied as one mixture. As well, the method may be performed on a plurality of garments substantially simultaneously.

Methods for making fabrics that resists liquid passage, in accord with an embodiment of the invention, include providing a fabric having pores, the fabric having a given critical surface tension if a fluorochemical is applied thereto, and the pores each having a size capable of permitting a given liquid having a surface tension that is no less than the given critical surface tension to pass therethrough if a fluorochemical is applied to the fabric; and applying an occluding composition to at least a selected portion of the fabric having the pores, the occluding composition being capable of substantially preventing passage of the given liquid through the pores while substantially allowing vapor passage through the pores.

In another embodiment of the invention, a formulation is described to treat a fabric with pores, the fabric having a given critical surface tension if a fluorochemical is applied thereto, the pores each having a size capable of permitting a given liquid having a surface tension that is no less than the given critical surface tension to pass therethrough if a fluorochemical is applied to the fabric. The formulation includes a fluorochemical; and a pore resistance composition, wherein the formulation substantially prevents passage of the given liquid through the pores while substantially allows vapor passage through the pores, when applied to the fabric.

In an alternate embodiment of the invention, a garment includes a denim fabric; and a microencapsulated odor neutralizing composition applied to a portion of the denim fabric. A related embodiment is a method for making such garments that includes providing a garment including a denim fabric; and applying a microencapsulated odor neutralizing composition to at least a portion of the denim fabric. The method may further include applying a crosslinking composition to the at least a portion of the denim fabric; and heating the garment to activate the crosslinking composition.

### BRIEF DESCRIPTION OF THE DRAWINGS

The foregoing features of the invention will be more readily understood by reference to the following detailed description, taken with reference to the accompanying drawings, in which:

FIG. 1 depicts a pair of pants that may be produced in accordance with various embodiments of the invention.

FIG. 2A depicts a fabric treated with a microencapsulated odor neutralizing composition before washing, in accord with illustrative embodiments of the invention.

FIG. 2B depicts a fabric treated with a microencapsulated odor neutralizing composition after 20 normal washings, in accord with illustrative embodiments of the invention.

FIG. 3 shows a process for producing garments consistent with illustrative embodiments of the invention.

FIG. 4 schematically shows equipment used to apply compositions to garments in some embodiments of the invention.

### DETAILED DESCRIPTION OF SPECIFIC EMBODIMENTS

In illustrative embodiments of the invention, garments and fabrics have a pore occluding composition that substantially prevents liquid penetration through relatively large pores (e.g., pores in denim). Although it prevents liquid penetration in those instances, such occluding composition nevertheless permits vapor passage through the pores, thus providing a more comfortable feel. In other embodiments, the garments and fabrics also may have stain resistance and release properties, wrinkle resistance, and odor neutralizing properties. Details of various embodiments are discussed below.

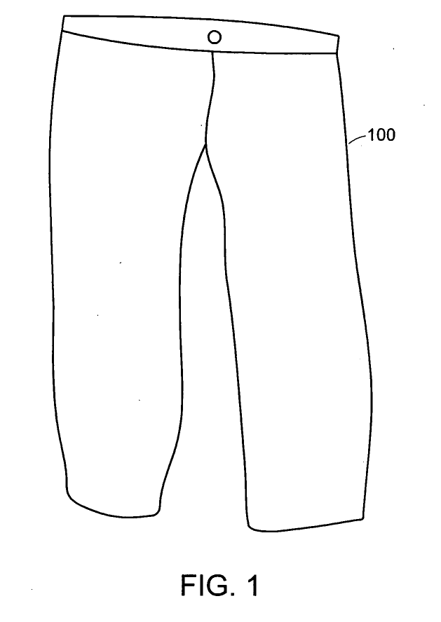

FIG. 1 shows a pair of pants 100 that may be produced in accordance with illustrative embodiments of the invention. Of course, discussion of the pants 100 is exemplary only and thus, not intended to limit the scope of various embodiments of the invention. Accordingly, aspects of embodiments applied to the pants 100 apply to other garments and fabric based articles, such as shirts, jackets, pants, shorts, hats, socks, shoes, gloves, umbrellas, furniture coverings, and undergarments.

Fabrics used to form the pants 100 may originate from a variety of natural and synthetic fibers, including blends of two or more different types of fibers. Examples of fibers include cotton, wool, rayon, polyesters, acrylics, flax, linen, lyocell, nylon, silk, or combinations of various types of fibers. The fabrics may come in a variety of patterns to form denims, corduroys, twills, knits, woven and non-woven fibers, among others.

To provide additional functionality, a liquid resistant composition is applied to the entire garment, or a portion of the garment. In illustrative embodiments, the garment may be texture-treated before the composition is applied. The liquid resistant composition imparts to the fabric the property of resisting liquid passage, while also allowing vapor passage through the fabric. Liquids include substances such as water, oils, mixtures of water and oil, and salts or other components that may be dispersed in water or oils or mixtures thereof. As one example, a liquid resistant composition include a fluorochemical. Such chemicals may lower the critical surface tension of a fabric surface below the surface tension of the liquid, causing liquids to “bead up” and not to pass through the fabric. For example, fluorochemical finishing agents, such as ScotchGuard™ (3M, St. Paul, Minn.) or Teflon™ (Du Pont, Wilmington, Del.) may be applied to the garment to lower the critical surface tension of a fabric of the garment to approximately 10 dynes per square centimeter. Thus liquids with a surface tension above the critical surface tension of the fabric will not penetrate the fabric (e.g., oils with surface tension of ˜20-25 dynes per square centimeter, aqueous solutions).

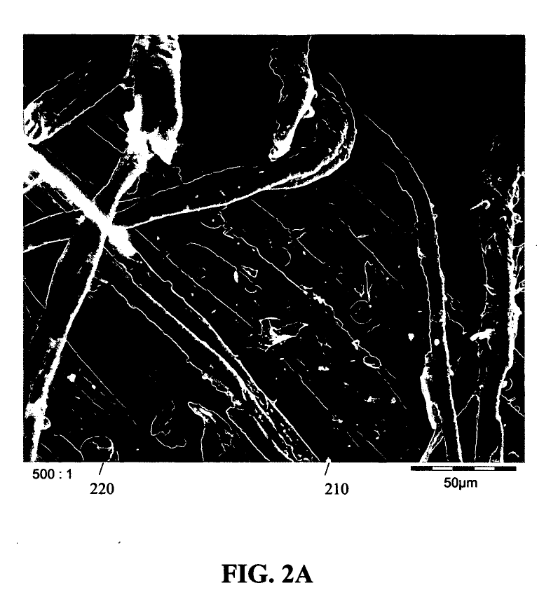

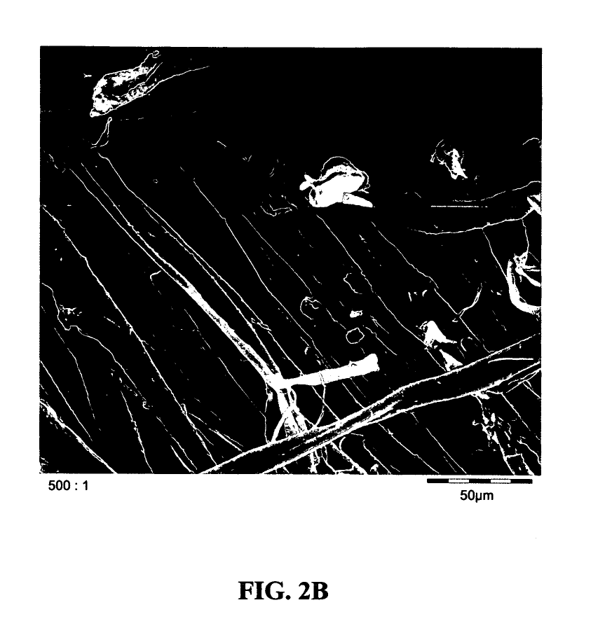

In another embodiment of the invention, garments may utilize a fabric with pores that typically allow a liquid to pass through the fabric when only a fluorochemical is applied. This occurs even though the liquid has a surface tension above the critical surface tension of the fabric with fluorochemical applied. As known in the art, pores refer to a void space in a fabric that connects one side of the fabric with another. Pores are not limited in the variety of sizes, shapes, and paths that they may have. For example, as shown in FIG. 2A, a pore may be a gap 210 between the fibers of a textile material. An occluding composition may be applied to illustrative garments. The occluding composition is configured (i.e., positioned on the fabric and oriented) to allow vapor passage through the pores of the fabric, so long as the pores are unobstructed by an externality such as dirt or other objects. As well, the occluding composition may occlude liquids from passing through the pores. Consequently, although a treated garment may be substantially “waterproof,” it still has the comfortable, “breathable” feel of untreated garments—that is, it still permits vapor passage through its pores.

Occluding compositions applied to a garment may include a pore resistance composition and a liquid resistant composition. The pores of the fabric have a size such that the occluding composition is capable of substantially preventing passage of a given liquid through the pores, while substantially allowing vapor passage. The pore resistance composition may be a composition of one or more components that act to effectively enhance resistance of liquid passage through the pores. A liquid resistant composition, such as a fluorochemical, may further act to lower the critical surface tension of the fabric surface below that of oil or water-based liquids. Accordingly, in illustrative embodiments, the pore resistant composition compliments the performance of the liquid resistant composition. In alternative embodiments, only one or the other type of composition may be used.

Pore resistance compositions that may be used with embodiments of the invention include waxes, polymers, and various types of non-hydrophilic compositions. Examples of pore resistance compositions include polyethylenes, polypropylenes, paraffins, carnauba waxes, or a mixture of components (e.g., a polyurethane wax). In one embodiment of the invention, the pore resistance composition uses a thermoplastic elastomer. Thermoplastic elastomers may be especially useful as a pore resistance composition since the pliable nature of the material may enable a garment treated with the thermoplastic elastomer to maintain a flexible, soft feel to the sense of touch. In another embodiment, the pore resistance composition includes a urethane component. For example, the pore resistance composition may be a blocked polyurethane with less than ten percent butanone oxime (Bayer AG, Germany).

Other compositions also may be applied to the garment to provide further advantages. Such compositions may be applied in any combination, with or without an occluding composition. In one embodiment of the invention, a crosslinking composition is applied to the garment. Crosslinking compositions may impart at least two properties to the fabrics to which they are applied. First, crosslinking compositions may react with functional groups of a fiber to impart structural stiffness to the fabric. Thus, the crosslinking compositions may impart a “wrinkle-resistant” property to the fabric, improving the aesthetic appearance of a garment. Second, crosslinking compositions can substantially improve the durability of a pore resistance composition or a liquid resistant composition that is applied to a fabric. When a pore resistance composition or liquid resistant composition is hydrophobic in nature, the composition may not adhere strongly to fabrics with fibers that are hydrophilic (e.g., cotton or rayon fibers). Crosslinking compositions that bind to hydrophilic fibers impart a hydrophobic nature to the fibers. Thus, the adhesion of fluorochemicals, polyurethanes, and other components of pore resistance compositions or liquid resistant compositions may be substantially improved.

Components of a crosslinking composition typically have at least two functional groups capable of reacting with hydroxyl groups on adjacent molecular chains in the amorphous regions of a cellulosic fiber. One particular type of crosslinking agent reacts not only with the cellulose, but also has the ability to self-polymerize, forming three-dimensional network polymers. These crosslinking agents are commonly referred to as aminoplast resins. Other types of crosslinking agents do not self-polymerize; these are commonly referred to as cellulose reactants.

Two major types of formaldehyde condensates, which may serve as aminoplast resins, are urea/formaldehyde and melamine/formaldehyde. Because of their tendency to self-crosslink, aminoplast resins tend to make fabrics/garments very stiff, which is often an undesirable characteristic. Aminoplast resins have relatively high formaldehyde contents, which present potential human exposure risks. Aminoplast resins are also renowned for their poor shelf lives, although this can be improved if the resins are methylated.

Cellulose reactants only crosslink with the fibers of a fabric; they are not prone to self polymerization. As such, fabrics treated with crosslinking compositions with this component exhibit a much softer hand than fabrics treated with aminoplast resins. Cellulose reactants also liberate considerably less formaldehyde than do aminoplast resins.

Types of cellulose reactants include dimethylol ethylene urea and dimethylol propylene urea. In a particular embodiment of the invention, a crosslinking composition includes a cellulose reactant which is dimethyl dihydroxy ethylene urea, commonly referred to as DMDHEU. DMDHEU is often referred to as glyoxal resin, since it is manufactured by reacting urea, formaldehyde, and glyoxal. DMDHEU may also be alkylated, which greatly reduces the undesirable release of formaldehyde.

Carbamates, a family of compounds that also react with formaldehyde to form N-methylol derivatives, may also be used as component of a crosslinking composition. Carbamates, which are simple urethanes, are more difficult to cure and require a stronger catalyst and/or higher curing temperatures, leading to greater strength loss of the fabrics/garments and less abrasion resistance. The commercial products also have higher free formaldehyde contents.

Nonformaldehyde-based crosslinking agents also may be used with embodiments of the invention. Examples of non-formaldehyde products include dimethyl dihydroxyethlene urea and butanetetracarboxylic acid. Non-formaldehyde crosslinking agents may have decreased crosslinking performance, higher cost, and less durability, relative to formaldehyde-based crosslinking agents.

Crosslinking compositions may include one or more of the components previously described. In addition, a crosslinking composition may include a catalyst that promotes the reaction of one of more components of the crosslinking composition when activated. For example, ionic salts may be added to the crosslinking composition to promote crosslinking when the applied composition's temperature is raised above a certain critical threshold.

Another composition that may be applied to a garment, in accord with embodiments of the invention, is an odor neutralizing composition. Components of an odor neutralizing composition may allow garments to be worn for extended periods of time, while minimizing the odor produced by components that may tend to accumulate on the garments. Odors may also originate from improper curing of compositions that are applied to garments; use of an odor neutralizing composition may help suppress such odors.

An example of an odor neutralizing composition includes a scent or fragrance may be applied to mask the odor produced by particular components. Another example of an odor neutralizing composition includes the use compositions that interact with odor causing sources to lower the vapor pressure of the source composition, and hence suppress the odor. A particular example of an odor neutralizing composition is a liposoluble essences of phosphate salts of 2,2′-oxybisethanol-2,2′-(methylimino)bisethanol (Bayer AG, Germany).

In a related embodiment of the invention, an odor neutralizing composition is encapsulated in a microscopic device (e.g, microencapsulant) to protect the composition from premature release. As shown in FIG. 2A, polyurethane microcapsules 220 hold an odor neutralizing composition. The microcapsules release their encapsulated composition when they are ruptured due to the ordinary wear that occurs during a garment's use. As shown in FIG. 2B, some microcapsules still remain intact after 20 normal washings in a washing machine. Embodiments of the invention utilizing polyurethane microcapsules can encapsulate a composition for at least 30 normal washings.

Still another composition that may be applied to garments, in accord with embodiments of the invention, is a softening composition. A softening composition may act to improve the tactile feel and softness of garments that are treated with the various compositions described herein. Examples of components that may constitute a portion, or the whole, of a softening composition include high density polyethylene, or a silicone based composition such as amino-modified copolymer silicone.

The various compositions described herein may be combined in one batch and applied to a fabric or garment all at once. Alternatively, the compositions may be applied in a series of applications.

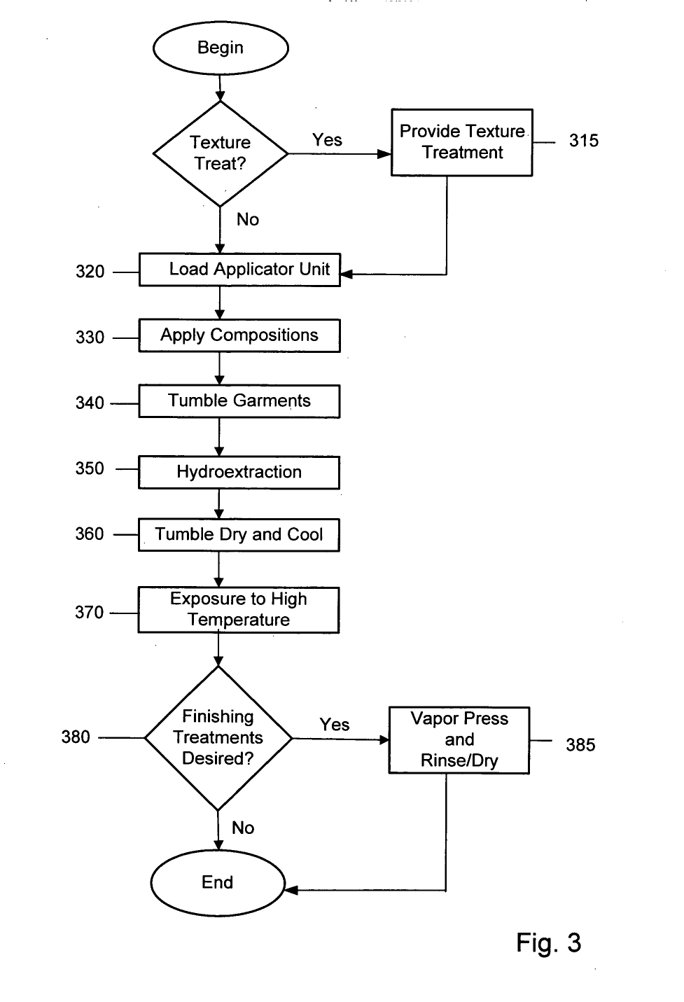

FIG. 3 shows a process for producing garments in accord with illustrative embodiments of the invention. The process at step 310, in which it is determined if the garments are to be texture-treated. Among other reasons, the garments may be texture treated to alter the appearance or quality of the fabric in the garment. For example, in this embodiment of the invention wherein the garments are pair of denim blue jeans (as depicted in FIG. 1), the denim fabric may be texture-treated (e.g., pre-washed) to impart a casual, aesthetic appearance (e.g., fading of color, shape of draping of pants when worn), and to increase the tactile attractiveness (i.e., softness) of the denim. Texture-treatments include industrial washings and rinsings; enzyme washes; sandblasting; stonewashing; and combinations of individual treatments. Garments, or the fabrics they are composed from, nevertheless need not be texture-treated. If garments are to be texture treated, then the process continues to step 315, in which they are texture-treated in accordance with conventional processes.

Alternatively, if the garment is not to be texture treated, or after texture treatment, the process continues to step 320, in which an applicator unit is loaded with garments for subsequent application of compositions to the garment. An applicator unit may be a batch-mode tumbling washer unit that is modified with a sprayer to apply the compositions to several garments substantially simultaneously. In one example, a tumbling washer unit with a 250 kilogram capacity (Washex, Inc., Wichita Falls, Tex.) is equipped with a multi-nozzle spray device (Spraying Systems Co., Inc., Wheaton, L). A quantity of texture-treated garments is loaded into the tumbling washer unit. The garments may be entrained with water, or may be dry.

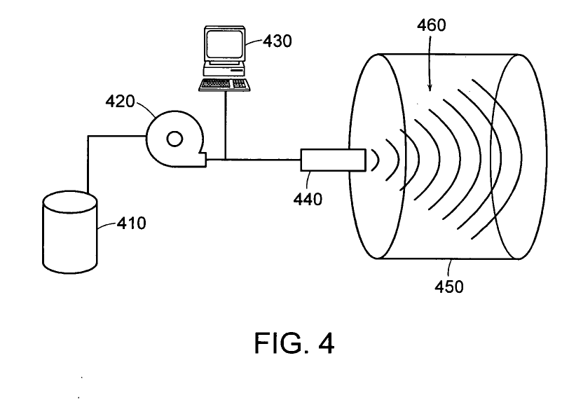

Compositions are applied to the garments in the tumbling washer unit using the multi-nozzle spray device (step 330). In this embodiment, the composition is a premixed liquor with components as described in Table 1 (below) dispersed as an aqueous solution, the components being a set of compositions that have been described earlier. As depicted in FIG. 4, a pump 420 removes liquid from one or more sources 410 that contain the components of the composition. A microprocessor 430 controls the metering of the premixed liquor into the tumbling washer unit. The washer unit includes a rotary drum 450 with a horizontally oriented axis of rotation. The drum 450 may be rotated in a clockwise or counter. The sprayer 440 releases the composition 460 into the drum 450 while the drum alternately rotates in a direction for a set period of time. The composition is applied in an amount such that the total liquid weight of the garments (any original liquid in the loaded garments plus applied composition) is approximately 30%-100% of the total dry weight of garments.

After the composition is applied to the garments, the garments are continually tumbled by the drum for a set period of time in alternating directions (step 340). In illustrative embodiments, the total time for applying the composition and tumbling may range from 1 minute to 1 hour.

Following tumbling, the garments are hydroextracted by spinning the drum to remove excess composition and other liquid entrained in the garments by centrifugation (step 350). Hydroextration is performed so that the garments retain a total weight of liquid greater than 50% of the dry weight of the garments. In one embodiment of the invention, hydroextraction is performed so that the garments retain a total weight of liquid in the range of approximately 65%-70% of the dry weight of the garments.

TABLE 1

| Component | Constituents | Amount |
|---|---|---|
| A | fluoroalkyl acrylate copolymer | 4.5% to 9.0% by weight of the |
| | emulsified in water, the | premixed liquor (preferably |
| | copolymer being greater than | 5.5% to 7.0% by wt.) |
| | 10% by weight of the total emulsion | |
| | (preferably greater than 15% by wt.) | |
| B | dispersed blocked polyurethane | weight ratio of 0.46-0.65 parts |
| | with less than 10% butanone | component B for each part |
| | oxime by weight in the total component | component A |
| C | inorganic salt with a carboxylic | weight ratio of 0.60-0.80 parts |
| | acid and 2-imidazolidinone | component C for each part |
| | reactant to form a crosslinking | component A |
| | emulsion, the reactant being no greater | |
| | than 30% by weight of the total | |
| | emulsion | |
| D | amino-modified copolymer | 1.25% to 3.5% by weight of |
| | silicone having softening | the total dry fibrous |
| | properties, the copolymer being | substrate/load (preferably |
| | no greater than 10% by weight of the | 1.5% to 2.5% by weight) |
| | total component | |
| E | a suspension of polyurethane | weight ratio of 0.75-0.99 parts |
| | microcapsules with liposoluble | component E for each part |
| | essences of phosphate salts of | component A (preferably |
| | 2,2′-oxybisethanol-2,2′- | between 0.78-0.89 parts) |
| | (methylimino) bisethanol, the salt being | |
| | no greater than 10% by weight of | |
| | the total suspension (preferably no | |
| | greater than 5%) | |

After hydroextraction, the liquid-entrained garments are removed from the applicator unit and loaded into a tumble dryer to dry the garments to a total liquid entrainment weight of approximately 5%-25% of the dry garment weight (step 360). Typical operating conditions for the tumble dryer are at 195° F. for 20 minutes. Following drying, the garments are subject to a cooling cycle where they are tumbled without heat for approximately 10 minutes.

Next, the garments are removed from the tumble dryer and hung upside down from worn orientation on a conveyor that transports the garments to an oven. The garments are exposed to oven conditions of a temperature of approximately 200° F. to 400° F. for approximately 1-30 minutes (step 370). Exposing the garments to high temperature activates the crosslinking composition, component C of Table 1, to initiate crosslinking between the composition and the fibers of the denim fabric. As well, the high temperature exposure allows the fluoroalkyl acrylate copolymer and blocked polyurethane, components B and C of Table 1, to distribute along fiber surfaces, which may enhance surface coverage of these components. The completed garment typically has a total weight of approximately 110% of its dry weight before processing occurs.

Finishing treatments may be subsequently applied to the garments to improve their aesthetic appearance and tactile appeal (step 380). For example, garments may be vapor pressed, rinsed and dried, or both 385. Vapor pressing may help garments retain a pressed, aesthetic appearance, while improving the softness of the garment, after treatment with the aforementioned compositions. Vapor presssing may be performed by pressing the garments into a specific configuration while subjecting the garment serially to 4 seconds of steam, 6 seconds of a steam/hot air mixture, and 4 seconds of hot air only. Rinsing the garments in water at approximately 100° F., followed by drying, may help to increase the softness of the garment's fabric.

Garments having the noted pore sizes and processed in the aforementioned manner should have the property of resisting oil and water passage through the fabric of the garment, while allowing vapor to penetrate through the fabric. As well, the crosslinking composition, component C of Table 1 imparts wrinkle-resistance to the garment, helping the garment maintain a particular orientation and appearance. The application of component E to the garments provides an odor neutralizing composition in the form of a composition that lowers the vapor pressure of odor sources to suppress odor formation, and a composition in the form of a scent to help mask odors that are emitted from the garment. Garments created by this process maintain their oil and water resistance, as well as their odor neutralizing capabilities for at least 30 typical consumer washings of the garment.

Numerous modifications to the processes and compositions described herein may be applied to create different fabric-based articles in a variety of manners, all in accord with embodiments of the present invention. For example, though many of the aforementioned embodiments of the invention are directed toward garments, the compositions and processes may also be applied generally to fabrics that are not pre-formed as garments. As well, the fabrics may be pre-formed as fabric-based articles that are not garments (e.g., draperies; upholstery such as used in furniture or car seat coverings; rugs and carpets; fabric-based wall hangings; and luggage or other fabric-based carrying implements).

Numerous alterations of the process of FIG. 3 may also be practiced to provide further embodiments of the invention. For example, garment texture treatment may be performed on the fabric of the garment before the garment is formed. The steps of evenly applying the compositions of interest to garments or fabrics (steps 320, 330, 340) may be performed by alternative methods. A plurality of compositions may be applied serially by sprayers as opposed the application of one premixed liquor. As well, other variations include creating one applicator/drying unit to perform the steps of composition application 330, hydroextraction 350, and tumble drying 360.

As an alternative to batch processing of garments by spraying and tumbling, a continuous process may be implemented that dips and agitates the garments in baths of the desired compositions. The actual compositions applied to garments or fabrics may include any number of the components or compositions described herein. Hydroextraction and tumble drying of garments and fabrics (steps 350 and 360) may be performed as part of the continuous process. For example, as opposed to centrifugation, garments may be pressed through a set of rollers to extract excess liquid, and blown dry while being conveyed. The high temperature heat exposure (step 370) may then be performed as an ending step of the process. Indeed, high temperature heat exposure may or may not be performed if a crosslinking composition is not applied to the garment or fabric.

All of the aforementioned embodiments of the invention are intended to be merely exemplary and numerous variations and modifications will be apparent to those skilled in the art. All such variations and modifications are intended to be within the scope of the present invention as defined in the appended claims.

### EXAMPLES

The following examples are provided to illustrate some embodiments of the invention, and are not intended to limit the scope of any particular embodiment utilized.

### Example 1

### A Process for Making Liquid-Resistant Denim Garments

In a 250-kg washer/extractor (Washex, Inc., Wichita Falls, Tex.) was loaded with approximately 90 prewashed, dry denim garments weighing 65 kilograms total. The machine was started to begin tumbling of the garments. While the garments were tumbling inside the machine, a 6-nozzle spray device in a horseshoe pattern arrangement, retrofitted to the washer/extractor, sprayed the premixed composition shown in Table 1 dispersed in water.

The spraying was regulated using a diaphragm air actuated pump, and carried out for a period of 10 minutes to 90% wet pickup (i.e., the amount of liquid entrained in the garments is equal to 90% of the dry weight of the garments). During spraying, tumbling was carried out in one rotational direction for 2 minutes, followed by tumbling in the opposite direction for subsequent minutes 2 minutes; the rotational direction being switched every 2 minutes. In total, three cycles of clockwise tumbling and two cycles of counterclockwise tumbling were performed. After spraying of the chemical composition was completed, tumbling was continued for an additional 10 minutes. Tumbling subsequent to composition addition consisted of 30 second alternating cycles of clockwise and counterclockwise directional tumbling.

When the tumbling was completed, the garments were hydroextracted to remove the excess moisture (remaining moisture was 65%-70% of the dry garment weight after hydroextraction) and unloaded from the washer. The garments were transferred to a tumble dryer and dried until only 10% moisture remained. The temperature of the tumble dryer was 210° F., and total tumble-drying time was 30 minutes. A cooling cycle was then initiated for approximately 10 minutes. Finally, the garments were hung from a chain conveyor and placed inside an oven where they were treated at 280° F. for 20 minutes to cross-link the chemical composition to the fibers. After completing the cycle in the oven, the garments were off loaded and vapor pressed with 6 seconds of steam, followed by 4 seconds of a steam/hot air mixture, and 4 seconds of hot air only.

### Example 2

### A Second Process for Making Liquid-Resistant Denim Garments

Using the washer/extractor described in Example 1, approximately 90 prewashed, wet denim garments weighing approximately 110 kilograms total (65 kilograms dry weight plus approximately 70% moisture retention) were loaded. Tumbling was initiated. While the garments were tumbling inside the washer/extractor, they were sprayed with a premixed liquor having the components described in Table 1, the liquor modified to account for dilution since garments were loaded into the machine wet.

The spraying was regulated using a diaphragm air actuated pump, and carried out for a period of 12 minutes to a 100% wet pickup. During spraying, tumbling was carried out in one rotational direction for 2 minutes, followed by tumbling in the opposite direction for 2 minutes; the rotational direction being switched every 2 minutes. In total, three cycles of clockwise tumbling and three cycles of counterclockwise tumbling were performed. After spraying of the chemical composition was completed, tumbling was continued for an additional 12 minutes. Tumbling subsequent to composition addition consisted of 30 second alternating cycles of clockwise and counterclockwise directional tumbling.

When the tumbling was completed, the garments were hydroextracted to remove the excess moisture (remaining moisture was 65%-70% of the dry garment weight after hydroextraction) and unloaded from the washer. The garments were transferred to a tumble dryer and dried until only 5 percent moisture was left in them. The temperature of the tumble dryer was 210° F., and total tumble-drying time was 30 minutes. A cooling cycle was then initiated for approximately 10 minutes. Finally, the garments were hung from a chain conveyor and placed inside an oven where they were treated at 300° F. for 15 minutes to cross-link the chemical composition to the fibers. After completing the cycle in the oven, the garments were off loaded and vapor pressed with 6 seconds of steam, followed by 4 seconds of a steam/hot air mixture, and 4 seconds of hot air only.

### Example 3

### Testing of a Treated Fabric

The following tests were carried out on a sample of denim fabric treated with the composition of Table 1 dispersed in water to determine the durability and performance of the treated sample. The sample was prepared using the process described in Example 1.

Oil Repellency Test

American Association of Textile Chemists and Colorists (AATCC) Test Method # 118 was utilized to measure the oil repellency of treated sample. The test assigns a relative value of the oily stain resistance for the sample being tested. Drops of standard test liquids consisting of a selected series of hydrocarbons are gently placed on the sample and allowed to remain for 30 seconds. The test liquid drops are then removed from the sample by wicking or wiping with a paper tissue. The sample is observed for remaining signs of wetting. Eight different oil challenge liquids are used with the number one liquid (“Kaydol” mineral oil) being the easiest to repel and the number eight liquid (n-Heptane) being the most difficult. The various test liquids are shown in Table 2. The sample is tested in a systematic manner beginning with the first liquid and progressing to the other liquids until one of the liquids is observed to wet the substrate after 30 seconds. Oil repellency is reported as the number value of the highest numbered liquid that did not wet the substrate. For detailed comparisons, multiple drops of each liquid are tested and whole numbers and fractions may be reported. In general, an oil repellency rating of 5 or higher is desired.

TABLE 2

| Rating | Test Liquid |
|---|---|
| 1 | Kaydol (mineral oil) |
| 2 | 35:65 mix of n-Hexadecane/Kaydol |
| 3 | n-Hexadecane |
| 4 | n-Tetradecane |
| 5 | n-Dodecane |
| 6 | n-Decane |
| 7 | n-Octane |
| 8 | n-Heptane |

Water/Alcohol Drop Repellency Test

The water/alcohol drop repellency test measures the ability of the substrate to repel various blends of water and isopropyl alcohol. Test drops of the liquid solutions with progressively higher percentages of isopropyl alcohol are applied to the treated sample. If after 30 seconds the applied solution does not soak into the sample, the solution is wicked or wiped away with a paper tissue. The surface of the sample is examined subsequently for surface wetting. Eleven blends of water and alcohol, as shown in Table 3, are used with 100% water being the easiest to repel and 100% isopropyl alcohol being the most difficult. The treated sample is given a number value corresponding to the solution having the highest concentration of isopropyl alcohol that the treated substrate was able to repel without observed wetting. For example, a sample is given a value of 4 if it is able to repel the solution consisting of 60 percent water and 40 percent isopropyl alcohol.

TABLE 3

| Rating | Composition of Test Liquid (wt. %) |
|---|---|
| W | 100 Water |
| 1 | 90/10 Water/Isopropyl Alcohol |
| 2 | 82/20 Water/Isopropyl Alcohol |
| 3 | 70/30 Water/Isopropyl Alcohol |
| 4 | 60/40 Water/Isopropyl Alcohol |
| 5 | 50/50 Water/Isopropyl Alcohol |
| 6 | 40/60 Water/Isopropyl Alcohol |
| 7 | 30/70 Water/Isopropyl Alcohol |
| 8 | 20/80 Water/Isopropyl Alcohol |
| 9 | 10/90 Water/Isopropyl Alcohol |
| 10 | 100 Isopropyl Alcohol |

Water Spray Test

The water spray test follows AATCC Test Method 22. The treated sample is held taut within a 6-inch ring at a 45° angle. Two hundred fifty milliliters of water at a temperature of 27° C. (±1° C.) is dropped onto the sample from a distance of 6 inches above the center of the substrate. After the application of water, the substrate is tapped lightly to remove excess water and is rated in a manner consistent with one of the entries in Table 4. A higher number indicates better water repellency. In general, a number of 65 or higher is desirable.

TABLE 4

| Rating | Degree of Water Repellency |
|---|---|
| 100 | No wetting of the surface |
| 90 | Wetting of the surface in a few small spots |
| 80 | Wetting of the surface in 6-15 separate spots |
| 70 | Wetting of the surface in center of fabric |
| 50 | Full wetting of surface in center of fabric |
| 0 | Complete wetting of entire fabric surface |

Wrinkle Release Rating Test

Samples to be tested are submitted to standard home laundering practices. Evaluation is performed using a standard lighting and viewing area by rating the appearance of the garments in comparison to appropriate reference standards. The procedure is summarized in Table 5.

TABLE 5

| | |
|---|---|
| Wash load ballast | Type I |
| Fiber content | 100 percent cotton |
| Fabric construction | 3/1 RHT |
| Fabric weight | 12.8 oz/sq yd |

Washing Machine Cycle Conditions

| | |
|---|---|
| Water level | 18 ± 1 gal |
| Agitator speed | 179 ± 2 rpm |
| Washing time | 12 min |
| Spin speed | 645 ± 15 rpm |
| Final spin cycle | 6 min |

Dryer Conditions

| | |
|---|---|
| Exhaust temperature | 66° ± 5° C. |
| Cool down time | 10 min |

Fabric Smoothness Grades by SA Replica Equivalents

| Grade | Description |
|---|---|
| SA-5 | Very smooth pressed appearance |
| SA-4 | Smooth finished appearance |
| SA-3 | Mussed, nonpressed appearance |
| SA-2 | Rumpled, obviously wrinkled appearance |

Composite Results:

A composite repellency rating is tabulated for the testing of a sample fabric (fabric weight ASTM D3776, 12.8 oz./yd²; fabric strength/durability ASTM D5034, warp: 162.90, fill: 136.4) treated with the composition of Table 1. The composite rating is calculated by summing the value obtained for each of the above tests/ratings as applied to a treated sample. The ratings for the water spray test are divided by 10 to normalize the score. The maximum composite rating possible is 33. The results are shown in Table 6.

TABLE 6

| | Maximum | Requirement | Newly Treated | Requirement | | |
|---|---|---|---|---|---|---|
| | Score | Score New | Sample | Score After | Sample Score | |
| Test | Possible | Sample | Score | Washing | After Washing | |
| H₂O/isopropyl | 10 | 10 | 10 | N/A | 7 | (after 30 |
| alcohol test | | | | | | washings) |
| Durable Press | 5 | 3.5 | 3.5 | 3 | 3.5 | (average |
| AATCC 143 | | | | | | value over 5 |
| | | | | | | washings) |
| Spray Test | 10 | 9 | 10 | 7 (after 30 | 8 | (after 30 |
| (score/10) | | | | washings) | | washings) |
| Oil Repellency | 8 | 5 | 5.5 | 3 (after 30 | 4 | (after 30 |
| AATCC 118 | | | | washings) | | washings) |
| Totals | 33 | 27.5 | 29 | N/A | 22.5 | |

1. A garment comprising:
a fabric having a plurality of pores; and
a thermoplastic elastomer applied to at least a selected portion of the fabric, the selected portion of the fabric including the plurality of pores, the thermoplastic elastomer being configured to allow vapor passage through the plurality of pores.

2. The garment according to claim 1 further comprising a liquid resistant composition applied to at least the selected portion of the fabric, the liquid-resistant composition substantially preventing a liquid from passing through the plurality of pores.

3. The garment according to claim 2, wherein the liquid resistant composition is a fluorochemical.

4. The garment according to claim 1, wherein the fabric is denim.

5. The garment according to claim 4, wherein the fabric is texture-treated denim.

6. The garment according to claim 1 further comprising a crosslinking composition applied at least to the selected portion of the fabric.

7. The garment according to claim 1 further comprising a microencapsulated odor neutralizing composition applied to at least the selected portion of the fabric.

8. A garment comprising:
a fabric having a plurality of pores, the fabric having a given critical surface tension if a fluorochemical is applied thereto, the plurality of pores each having a size capable of permitting a given liquid having a surface tension that is no less than the given critical surface tension to pass therethrough if a fluorochemical is applied to the fabric; and
an occluding composition applied to at least a selected portion of the fabric, the selected portion including the plurality of pores, the occluding composition being capable of substantially preventing passage of the given liquid through the plurality of pores while substantially allowing vapor passage through the plurality of pores.

9. The garment according to claim 8, wherein the fabric includes denim.

10. The garment according to claim 9, wherein the denim is texture-treated.

11. The garment according to claim 8, wherein the fabric is texture-treated.

12. The garment according to claim 8, wherein the occluding composition includes a liquid resistant composition.

13. The garment according to claim 12, wherein the liquid resistant composition includes a fluorochemical.

14. The garment according to claim 8, wherein the occluding composition includes a pore resistance composition.

15. The garment according to claim 14, wherein the pore resistance composition includes a wax.

16. The garment according to claim 14, wherein the pore resistance composition includes a thermoplastic elastomer.

17. The garment according to claim 16, wherein the thermoplastic elastomer includes a urethane.

18. The garment according to claim 8 further including a crosslinking composition applied to at least the selected portion of the fabric.

19. The garment according to claim 18, wherein the crosslinking composition includes a wrinkle-resistant composition.

20. The garment according to claim 19, wherein the crosslinking composition includes an inorganic salt and 2-imidazolidinone.

21. The garment according to claim 18, wherein the crosslinking composition includes a glyoxal-based agent.

22. The garment according to claim 8 further including a microencapsulated odor neutralizing composition applied to at least the selected portion of the fabric.

23. The garment according to claim 22, wherein the microencapsulated odor neutralizing composition is capable of decreasing the vapor pressure of an odor composition.

24. The garment according to claim 22, wherein the microencapsulated odor neutralizing composition includes a scent composition.

25. The garment according to claim 22, wherein the microencapsulated odor neutralizing composition includes liposoluble essences of phosphate salts of 2,2′-oxybisethanol-2,2′-(methylimino)bisethanol.

26. The garment according to claim 8 further including a softening agent applied to at least the selected portion of the fabric.

27. The garment according to claim 26, wherein the softening agent includes an amino-modified copolymer silicone.

28. A fabric comprising:
a fabric surface having a plurality of pores, the fabric having a given critical surface tension if a fluorochemical is applied thereto, the plurality of pores each having a size capable of permitting a given liquid having a surface tension that is no less than the given critical surface tension to pass therethrough if a fluorochemical is applied to the fabric; and
an occluding composition applied to at least a selected portion of the fabric, the selected portion including the plurality of pores, the occluding composition being capable of substantially preventing passage of the given liquid through the plurality of pores while substantially allowing vapor passage through the plurality of pores.

29. The fabric according to claim 28, wherein the fabric includes denim.

30. The fabric according to claim 29, wherein the denim is texture-treated.

31. The fabric according to claim 28, wherein the fabric is texture-treated.

32. The fabric according to claim 28, wherein the occluding composition includes a liquid resistant composition.

33. The fabric according to claim 32, wherein the liquid resistant composition is a fluorochemcial.

34. The fabric according to claim 28, wherein the occluding composition includes a pore resistance composition.

35. The fabric according to claim 34, wherein the pore resistance composition includes a thermoplastic elastomer.

36. The fabric according to claim 35, wherein the thermoplastic elastomer includes a urethane.

37. The fabric according to claim 28 further including a crosslinking composition applied to at least the selected portion of the fabric.

38. The fabric according to claim 37, wherein the crosslinking composition includes a wrinkle-resistant composition.

39. The fabric according to claim 38, wherein the crosslinking composition includes an inorganic salt and 2-imidazolidinone.

40. The fabric according to claim 37, wherein the crosslinking composition includes a glyoxal-based agent.

41. The fabric according to claim 28 further including a microencapsulated odor neutralizing composition applied to at least the selected portion of the fabric.

42. The fabric according to claim 41, wherein the microencapsulated odor neutralizing composition is capable of decreasing the vapor pressure of an odor composition.

43. The fabric according to claim 41, wherein the microencapsulated odor neutralizing composition includes a scent composition.

44. The fabric according to claim 41, wherein the microencapsulated odor neutralizing composition includes liposoluble essences of phosphate salts of 2,2′-oxybisethanol-2,2′-(methylimino)bisethanol.

45. The fabric according to claim 28 further including a softening agent applied to at least the selected portion of the fabric.

46. The fabric according to claim 45, wherein the softening agent includes an amino-modified copolymer silicone.

47. A method of making a garment, the method comprising:
providing a garment; and
applying a composition to at least a portion of the garment, the composition being capable of substantially resisting liquid passage through the portion of the garment, and substantially allowing vapor passage through the portion of the garment.

48. The method according to claim 47 further including:
heating the garment to spread the composition on the garment.

49. The method according to claim 47, wherein, in providing, the garment includes denim.

50. A method according to claim 49, wherein providing the garment includes providing texture-treated denim.

51. A method according to claim 47, wherein, in providing, the garment includes a texture-treated fabric.

52. The method according to claim 47, wherein applying the composition includes:
evenly applying an excessive amount of the composition to the garment; and
removing an extra amount of the composition from the garment.

53. A method according to claim 52, wherein evenly applying the composition includes:
spraying the excessive amount of composition on the garment while tumbling the garment.

54. A method according to claim 52, wherein removing includes:
hydroextracting a portion of the extra amount of the composition from the garment; and
drying the garment to remove a remaining portion of the extra amount of the composition from the garment.

55. The method according to claim 47, wherein the composition includes a liquid resistant composition.

56. The method according to claim 55, wherein the liquid resistant composition includes a fluorochemical.

57. The method according to claim 47, wherein the composition includes a pore resistance composition.

58. The method according to claim 57, wherein the pore resistance composition includes a thermoplastic elastomer.

59. The method according to claim 47, wherein the composition includes a crosslinking composition applied to at least the selected portion of the fabric.

60. The method according to claim 59, wherein the crosslinking composition includes a wrinkle-resistant composition.

61. The method according to claim 47, wherein the composition includes a microencapsulated odor neutralizing composition applied to at least the selected portion of the fabric.

62. The method according to claim 47, wherein the composition includes a softening agent applied to at least the selected portion of the fabric.

63. The method according to claim 47, wherein applying the composition includes applying the composition as one mixture.

64. The method according to claim 47, wherein method is performed on a plurality of garments substantially simultaneously.

65. A garment processed according to claim 47.

66. A method of making a fabric that resists liquid passage, the method comprising:
providing a fabric having a plurality of pores, the fabric having a given critical surface tension if a fluorochemical is applied thereto, the plurality of pores each having a size capable of permitting a given liquid having a surface tension that is no less than the given critical surface tension to pass therethrough if a fluorochemical is applied to the fabric; and
applying an occluding composition to at least a selected portion of the fabric, the selected portion including the plurality of pores, the occluding composition being capable of substantially preventing passage of the given liquid through the plurality of pores while substantially allowing vapor passage through the plurality of pores.

67. The method according to claim 66 further including:
heating the fabric to spread the occluding composition on the fabric.

68. The method according to claim 66, wherein, in providing, the fabric includes denim.

69. The method according to claim 68, wherein providing the fabric includes providing texture-treated denim.

70. The method according to claim 66, wherein, in providing, the fabric includes a texture-treated fabric.

71. The method according to claim 66, wherein applying the occluding composition includes:
evenly applying an excessive amount of the occluding composition to the fabric; and
removing an extra amount of the occluding composition from the fabric.

72. The method according to claim 71, wherein evenly applying the occluding composition includes:
spraying the excessive amount of occluding composition on the fabric while tumbling the fabric.

73. The method according to claim 71, wherein removing includes:
hydroextracting a portion of the extra amount of the occluding composition from the fabric; and
drying the garment to remove a remaining portion of the extra amount of the occluding composition from the fabric.

74. The method according to claim 66, wherein the occluding composition includes a liquid resistant composition.

75. The method according to claim 74, wherein the liquid resistant composition includes a fluorochemical.

76. The method according to claim 66, wherein the occluding composition includes a pore resistance composition.

77. The method according to claim 76, wherein the pore resistance composition includes a thermoplastic elastomer.

78. The method according to claim 66, wherein the occluding composition includes a crosslinking composition applied to at least the selected portion of the fabric.

79. The method according to claim 78, wherein the crosslinking composition includes a wrinkle-resistant composition.

80. The method according to claim 66, wherein the occluding composition includes a microencapsulated odor neutralizing composition applied to at least the selected portion of the fabric.

81. The method according to claim 66, wherein the occluding composition includes a softening agent applied to at least the selected portion of the fabric.

82. The method according to claim 66, wherein applying the occluding composition includes applying the occluding composition as one mixture.

83. The method according to claim 66, wherein the method is performed on a plurality of fabrics substantially simultaneously.

84. A fabric processed according to claim 66.

85. A fabric-based article comprising:
a fabric having a plurality of pores, the fabric having a given critical surface tension if a fluorochemical is applied thereto, the plurality of pores each having a size capable of permitting a given liquid having a surface tension that is no less than the given critical surface tension to pass therethrough if a fluorochemical is applied to the fabric; and
an occluding composition applied to at least a selected portion of the fabric, the selected portion including the plurality of pores, the occluding composition being capable of substantially preventing passage of the given liquid through the plurality of pores while substantially allowing vapor passage through the plurality of pores.

86. A formulation to treat a fabric with a plurality of pores, the fabric having a given critical surface tension if a fluorochemical is applied thereto, the plurality of pores each having a size capable of permitting a given liquid having a surface tension that is no less than the given critical surface tension to pass therethrough if a fluorochemical is applied to the fabric, the formulation comprising:
a fluorochemical; and
a pore resistance composition
wherein the formulation substantially prevents passage of the given liquid through the plurality of pores while substantially allows vapor passage through the plurality of pores, when applied to the fabric.

87. A garment comprising:
a denim fabric; and
a microencapsulated odor neutralizing composition applied to a portion of the denim fabric.

88. The garment according to claim 87, wherein the microencapsulated odor neutralizing composition is capable of decreasing the vapor pressure of an odor composition.

89. The garment according to claim 87, wherein the microencapsulated odor neutralizing composition includes a scent composition.

90. The garment according to claim 87, wherein the microencapsulated odor neutralizing composition includes liposoluble essences of phosphate salts of 2,2′-oxybisethanol-2,2′-(methylimino)bisethanol.

91. The garment according to claim 87, wherein the denim fabric is texture treated.

92. A method for making a garment with an odor neutralizing composition, the method comprising:
providing a garment including a denim fabric; and
applying a microencapsulated odor neutralizing composition to at least a portion of the denim fabric.

93. The method according to claim 92 further comprising:
applying a crosslinking composition to the at least a portion of the denim fabric; and
heating the garment to activate the crosslinking composition.

94. The method according to claim 92, wherein the denim fabric is texture treated.

95. A garment processed according to claim 92.
